(19) United States
(12) Patent Application Publication
(10) Pub. No.: US 2008/0273703 A1
(43) Pub. Date: Nov. 6, 2008

(54) Dual-Gated Qkd System for Wdm Networks

(75) Inventor: Michael J. LaGasse, Nahant, MA (US)

Correspondence Address: OPTICUS IP LAW, PLLC, 7791 ALISTER MACKENZIE DRIVE, SARASOTA, FL, 34240, US

(73) Assignee: MAGIQ TECHNOLOGIES, INC., New York, NY (US)

(21) Appl. No.: 11/662,554

(22) PCT Filed: Sep. 14, 2005
(86) PCT No.: PCT/US05/32602

§ 371 Date: Mar. 12, 2007

Related U.S. Application Data
(60) Provisional application No. 60/610,049, filed on Sep. 15, 2004.

(51) Int. Cl. H04L 9/08

(52) U.S. Cl. 380/278

(57) ABSTRACT

Systems and methods of incorporating a QKD system (Q) into a WDM network (2) are disclosed. The methods include electrically gating the single-photon detectors (SPDs) (30, 30′) as well as optically gating the SPDs with optical gates (28, 28′). The electronic gating width (TSPD) and the optical gating width (TOG) are selected to significantly reduce noise from scattered photons. The combined optical and electronic gating of the SPDs provides for Fourier-transform-limited detection of the quantum signal (SQ) that is not otherwise possible in a WDM-QKD system that employs only electronic SPD gating.

### CLAIM OF PRIORITY

This application claims the benefit of priority under 35 U.S.C. § 119(e) of U.S. Provisional Patent Application Ser. No. 60/610,049, filed on Sep. 15, 2004.

### TECHNICAL FIELD OF THE INVENTION

The present invention relates to and has industrial utility in connection with quantum cryptography, and in particular relates to systems and methods that allow for quantum key distribution (QKD) to be combined with a wavelength-division multiplexed (WDM) network to provide high data transmission rates for secure data transmission.

### BACKGROUND OF THE INVENTION

Quantum key distribution involves establishing a key between a sender (“Alice”) and a receiver (“Bob”) by using weak (e.g., 0.1 photon on average) optical signals transmitted over a “quantum channel.” The security of the key distribution is based on the quantum mechanical principle that any measurement of a quantum system in unknown state will modify its state. As a consequence, an eavesdropper (“Eve”) that attempts to intercept or otherwise measure the quantum signal will introduce errors into the transmitted signals and reveal her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). Specific QKD systems are described in U.S. Pat. No. 5,307,410 to Bennett (which patent is incorporated by reference herein), and in the article by C. H. Bennett entitled “Quantum Cryptography Using Any Two Non-Orthogonal States”, Phys. Rev. Lett. 68 3121 (1992).

The general process for performing QKD is described in the book by Bouwmeester et al., “The Physics of Quantum Information,” Springer-Verlag 2001, in Section 2.3, pages 27-33. During the QKD process, Alice uses a random number generator (RNG) to generate a random bit for the basis (“basis bit”) and a random bit for the key (“key bit”) to create a qubit (e.g., using polarization or phase encoding) and sends this qubit to Bob.

The performance of a QKD system is degraded by noise in the form of photons generated by three different mechanisms: 1) forward Raman scattering, in which frequency-shifted photons are generated and co-propagate with the quantum signal photons; 2) Raman backscattering, in which frequency-shifted photons are generated and propagate in the opposite direction to the quantum signal photons; and 3) Rayleigh scattering, in which photons from the quantum signal are elastically scattered back in the opposite direction of the quantum signal photons.

Even if the above-described sources of photon noise could be entirely eliminated, the data transmission rate of a single-wavelength (i.e., single channel) QKD system is limited because of the response times and the noise inherent in single-photon detectors (SPDs).

A number approaches to increasing QKD data transmission rates in view of the above-mentioned limitations have been proposed. One approach is to combine QKD with wavelength-division multiplexing (WDM), as suggested by Brassard et al., in the article “Multi-user quantum key distribution using wavelength division multiplexing,” G. Brassard, F. Bussieres, N. Godbout, and S. Lacroix, Proc. SPIE, v. 5260, pp. 149-153, 2003 (hereinafter, “the Brassard reference.”). Such a system would have multiple quantum channels operating over the same optical fiber but at different wavelengths.

However, the Brassard reference does not address the practical limitations of using QKD with WDM that need to be addressed in order to realize a commercial WDM-QKD system. In particular, the SPDs in a QKD system are electronically time-gated with a gating window that is much larger than the pulse-width of the optical signal. While this arrangement works reasonably well for a single-wavelength QKD system, the detection of scattered light (particularly Raman-scattered light) by the SPDs by a multiple-wavelength QKD system becomes problematic.

Attempting to decrease the SPD gating window size to allow less scattered light to be detected at first glance seems to be an obvious way to mitigate the scattered light problem. However, it turns out that the quantum efficiently (QE) of an SPD actually worsens as the SPD gating window is narrowed down closer to the width of the weak optical pulse being detected. This is due to the inherent jitter in SPDs, such as in avalanche photodiode detectors (APDs). To reduce the electronic noise in the SPDs, the SPD gating window must be big enough to account for jitter, which is typically ˜500 ps. This precludes the option of mitigating the detection of scattered light present in a WDM network by using Fourier-transform-limited detection in the QKD system.

### DESCRIPTION OF THE INVENTION

The present invention includes systems and methods of incorporating a QKD system into a WDM network. The methods include both optically and electrically gating the single-photon detectors (SPDs) in the system in a manner that significantly reduces noise from scattered photons. In particular, the method includes providing an optical gate adjacent each SPD, and electronically gating the SPD with an SPD window that is sufficiently wide to accommodate the inherent SPD jitter and minimize the amount of inherent detector noise. The method also includes optically gating the detector with an optical gate having a gating window narrower than the SPD window, and that is close in size to the width of the quantum signal. In an example embodiment, this provides Fourier-transform-limited detection of the quantum signal, which is not otherwise possible in a system that employs only electronic SPD gating. The result is a drastic reduction of noise due to scattered photons, which photons would otherwise prevent a commercially viable QKD system from operating over a standard WDM network.

Accordingly, a first aspect of the invention is a method of reducing an amount of detected noise in a QKD system having one or more single-photon detectors (SPDs) adapted to detect a quantum signal having a quantum signal width. The method includes electronically gating each SPD with an electronic gating signal that provides each SPD with a gating window having a first width centered on an expected arrival time of the quantum signal. The method also includes optically gating each SPD with an optical gate adapted to receive an electronic gating signal that provides the optical gate with a gating window having a second width centered on the expected arrival time of the quantum signal, wherein the first width is greater than the second width.

A second aspect of the invention is a QKD system having a first QKD station adapted to generate a selectively randomly modulated quantum signal having a first wavelength and send it to a second QKD station over a WDM network adapted to transmit non-quantum optical signals of different wavelengths. The second QKD station is adapted to receive the modulated quantum signal and selectively randomly modulate the modulated quantum signal to form an encoded quantum signal. The second QKD station includes one or more SPDs that are adapted to detect the encoded quantum signal and that are electronically gated to limit electronic noise when detecting the encoded quantum signal. The system also includes, at the second QKD station, one or more optical gates optically coupled to respective optical detectors, wherein each optical gate is gated to correspond to an expected arrival time of the encoded quantum signal and having a gating window sized to limit an amount of scattered light from reaching the one or more SPDs. In an example embodiment of this second aspect, the system is adapted to achieve Fourier-transform limited detection by making the gating of the optical gate correspond closely in size to the quantum signal.

### BRIEF DESCRIPTION OF THE DRAWINGS

FIG. 1 is a schematic diagram of a WDM network that includes a QKD system;

FIG. 2 is a schematic diagram of an example embodiment of the QKD system that is part of the WDM network of FIG. 1 and that employs the detector gating systems and methods of the present invention;

FIG. 3 is a close-up schematic diagram of an example embodiment of the QKD system of FIG. 2, wherein a single optical gate is optically coupled to the two SPDs; and

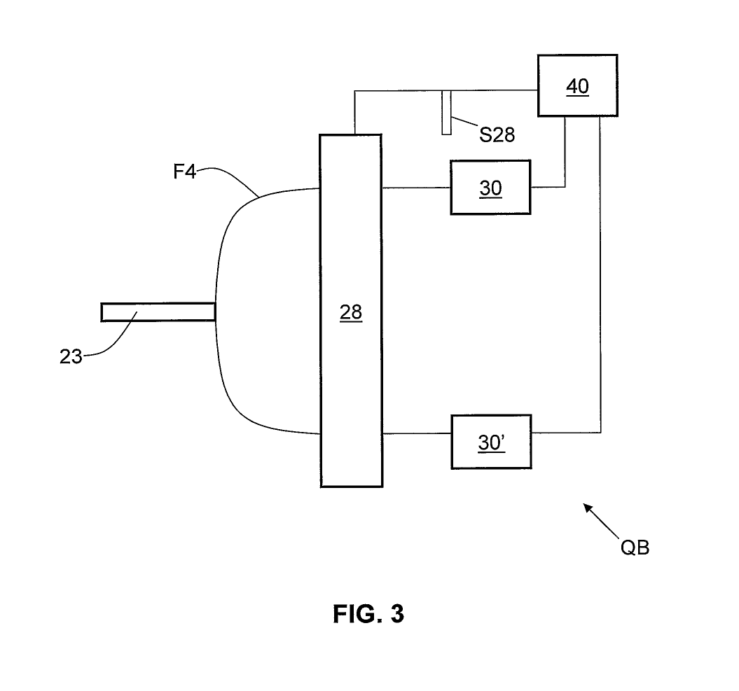

FIG. 4 is a timing diagram illustrating the size (width) and position of the SPD gating window and the optical gate gating window relative to the quantum signal to be detected.

The various elements depicted in the drawings are merely representational and are not necessarily drawn to scale. Certain sections thereof may be exaggerated, while others may be minimized. The drawings are intended to illustrate various embodiments of the invention that can be understood and appropriately carried out by those of ordinary skill in the art.

### DETAILED DESCRIPTION OF THE BEST MODE OF THE INVENTION

The description below first presents a WDM network that includes a QKD system operating over the network. This arrangement is referred to hereinbelow as a WDM-QKD system. An example embodiment of a QKD system according to the present invention and suitable for use with the WDM network is then set forth.

WDM Network with QKD

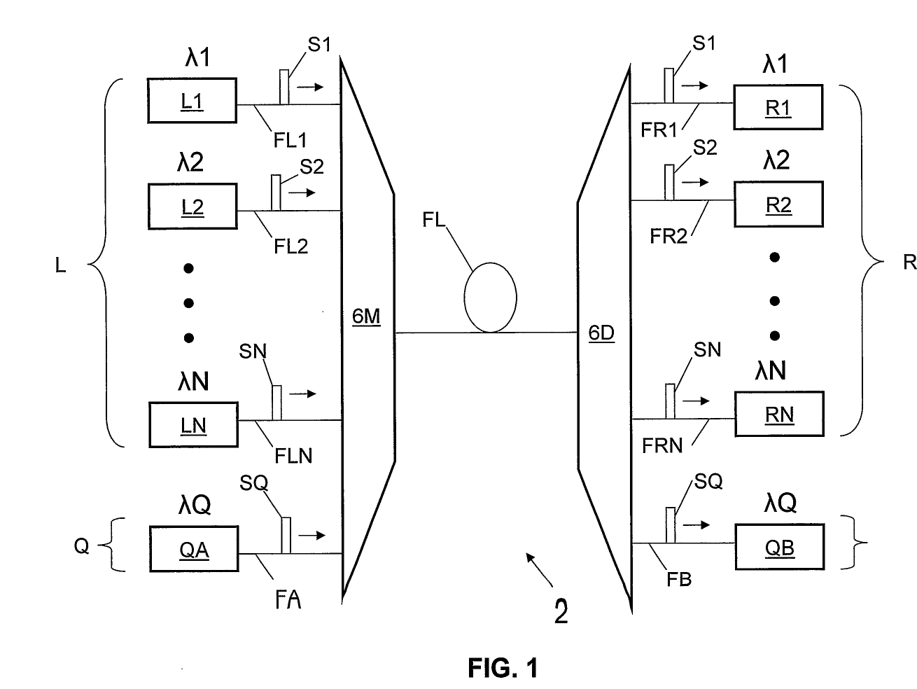

FIG. 1 is a schematic diagram of a WDM network 2. Network 2 includes a number (N) of light source systems L (e.g., L1, L2, . . . LN) that operate at respective wavelengths (channels) λ1, λ2, . . . λN and emit respective optical signals S1, S2, . . . SN. In an example embodiment, the optical signals S1, S2, . . . SN are relatively strong (i.e., non-quantum) optical signals.

Network 2 also includes a QKD system Q that operates at a wavelength (quantum channel) λQ and that emits quantum signals SQ. Quantum signals SQ are understood herein to include single photons, or alternatively weak optical pulses having on average less than one photon per pulse.

QKD system Q includes two QKD stations QA and QB. In a two-way QKD system, the term “quantum signals” also include initially relatively strong optical pulses that are later attenuated to serve as the weak optical pulses that provide for the ideally secure exchange of a key between the QKD stations.

Light source systems L are optically coupled to a WDM multiplexer 6M via respective optical fiber sections FL1, FL2, . . . FLN. Likewise, QKD station QA of QKD system Q is optically coupled to WDM multiplexer 6M via an optical fiber section FA. WDM multiplexer 6M is optically coupled to a WDM demultiplexer 6D by an optical fiber link FL capable of supporting the multiple wavelengths λ1, λ2, . . . λN, and λQ.

Network 2 also includes a number (N) of receiver systems R (e.g., R1, R2, . . . RN) that operate at respective wavelengths (channels) λ1, λ2, . . . λN, and that are adapted to receive respective signals S1, S2, . . . SN. Receiver systems R are optically coupled to WDM demultiplexer 6D via respective optical fiber sections FR1, FR2, . . . FRN. Likewise, QKD station QB is optically coupled to WDM demultiplexer 6D via an optical fiber section FB and is adapted to receive and process quantum signals SQ at wavelength λQ.

In a preferred example embodiment, WDM multiplexer 6M and WDM demultiplexer 6D are adapted to provide a high degree of isolation between adjacent wavelengths (channels), e.g., via the use of high-isolation filters, such as high-isolation thin-film filters. In particular, the WDM multiplexer and demultiplexer have an isolation that rejects side modes and amplified spontaneous emission (ASE) at the QKD wavelength λQ.

QKD System for Use with WDM Network

The present invention applies to both one-way QKD systems and two-way QKD systems. For the sake of illustration, the present invention is described in the context of a one-way QKD system. Application of the present invention to a two-way system follows in a straightforward manner from the description herein.

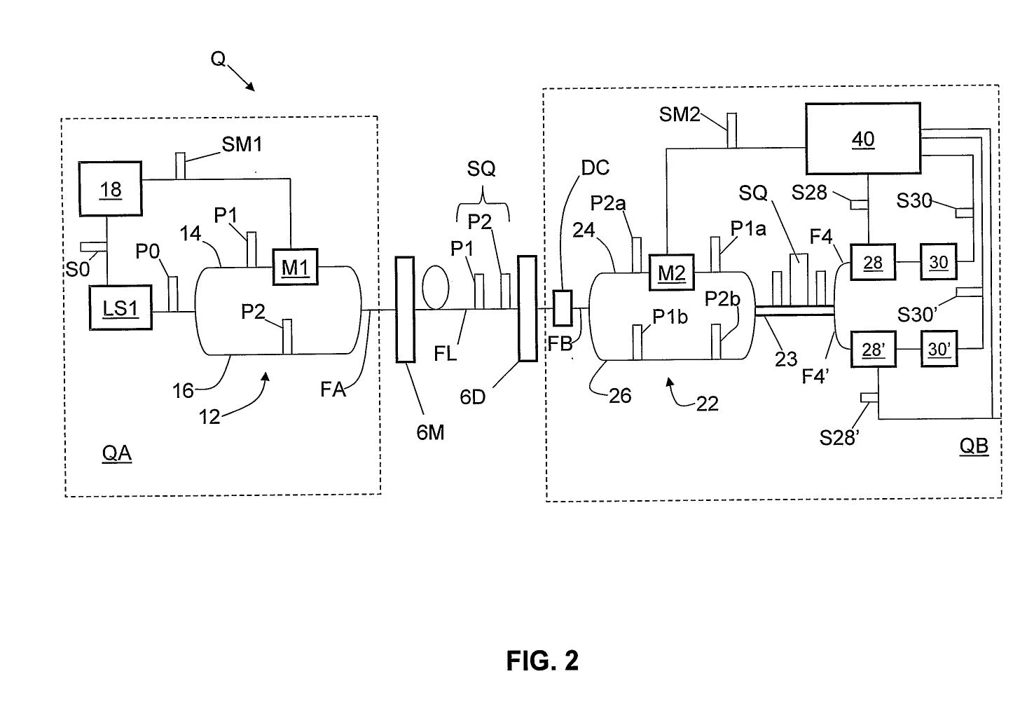

FIG. 2 is a schematic diagram of an example embodiment of a QKD system Q as part of WDM network 10 of FIG. 1, as adapted for use therein in accordance with the present invention. QKD station QA includes a laser source LS1 and a first interferometer loop 12 with arms 14 and 16 that have different lengths. Laser LS1 and interferometer loop 12 constitute an example of an optical system adapted to create two coherent optical pulses from a single light pulse.

One of the interferometer arms (say, 14) includes a modulator M1 (polarization or phase). Interferometer loop 12 is coupled to WDM multiplexer 6M via an optical fiber section FA, which as mentioned above, is coupled to WDM demultiplexer 6D via optical fiber link FL.

QKD station QA also includes a controller 18 coupled to light source LS1 and to modulator M1. Controller 18 is adapted to control and coordinate the operation of these devices in conjunction with controller 40 of station QB (discussed below).

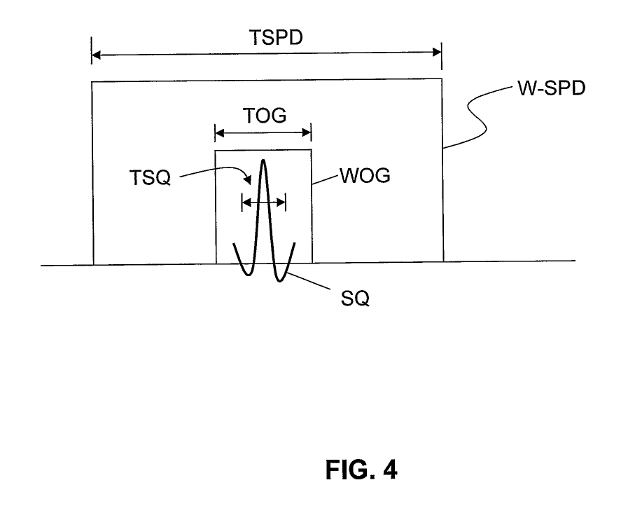

With continuing reference to FIG. 2, optical fiber link FB optically couples WDM demultiplexer 6D to second interferometer loop 22 at Bob. Loop 22 includes arms 24 and 26 of different lengths and includes a modulator M2 (polarization or phase) in one of the arms (say arm 24). For the sake of illustration, loop 22 is shown coupled to an optical coupler 23, which has two output optical fiber sections F4 and F4′. Optical coupler 23 is not drawn to scale in order to show the various optical pulses combined at the coupler, as discussed below. Optical fiber sections F4 and F4′ include respective optical gating elements (“optical gates”) 28 and 28′ which are in turn optically coupled to respective SPDs 30 and 30′. Optical gates 28 and 28′ each consist of or include a high-speed switch, such as a high-speed modulator, e.g., a lithium niobate modulator capable of sharply switching at speeds on the order of 10 picoseconds (ps). In an example embodiment illustrated in the close-up view of FIG. 4, a single optical gate 28 optically coupled to SPDs 30 and 30′ is used rather than employing two different optical gates for each SPD.

QKD station QB further includes a controller 40 operatively coupled to optical gates 28 and 28′, SPDs 30 and 30′, and modulator M2. Controller 40 is adapted to control and coordinate the operation of these devices in conjunction with controller 18 of QKD station QA, as described below.

### Operation of the QKD System in the WDM Network

In QKD system Q in WDM network 2 (FIG. 1), controllers 18 and 40 at respective QKD stations QA and QB are in operative communication (e.g., via synchronization signals, not shown, sent over fiber link FL) to coordinate the operation of the various devices, such as the laser source L1, the modulators M1 and M2, the optical gates 28 and 28′ and the SPDs 30 and 30′.

Thus, in the operation of the WDM-QKD system, controller 18 sends a timed control signal S0 that directs laser source LS1 to generate a light pulse P0 at a given time. Light pulse P0 is then divided into two pulses P1 and P2 by first interferometer loop 12. One of the pulses (say P1) is randomly modulated by modulator M1 via the direction of controller 18 via a timed modulator signal SM1. The modulation is randomly selected (e.g., via a random number generator) from a plurality of predetermined modulation values. This type of modulation is referred to hereinbelow as “selective random modulation.”

The two pulses P1 and P2, which are now separated due to the different optical path lengths of the interferometer arms, are attenuated (e.g., via a variable optical attenuator, not shown) down to the required weakness of a quantum signal. The pulses P1 and P2 (which in the present example embodiment constitute quantum signal SQ) then travel over fiber section FA to WDM multiplexer 6M. WDM multiplexer 6M then multiplexes pulses P1 and P2 (i.e., signal SQ at wavelength λQ) onto fiber link FL, along with the other signals S1, S2, . . . SN from light source systems L1, L2, . . . LN (FIG. 1). WDM demultiplexer 6D demultiplexes signals S1, S2, . . . SN and signal SQ and directs signal SQ to fiber section FB, which carries signal SQ to second interferometer loop 22.

At interferometer 22, each pulse P1 and P2 is split into two pulses (P1 into P1a and P1b, and P2 into P2a and P2b). Two of the pulses (say P1a and P2a) travel over arm 24, while the other two pulses (say P1b and P2b) travel over arm 26. One of these pulses (say, P2a) travels over arm 24 undergoes selective random modulation by modulator M2 via a timed modulator signal SM2 from controller 40.

The second interferometer loop then combines the pulses at optical coupler 23. If the two interferometer loops 12 and 22 have the same path length (e.g., the lengths of arms 14 and 24 are the same and the lengths of arms 16 and 26 are the same), then the two pulses that travel the same optical path length (say, pulses P1b and P2a) are recombined (interfered) to create a single interfered pulse.

For the sake of discussion, the interfered pulse is also referred to as quantum signal SQ. The quantum signal SQ at this point can be considered as “encoded” because it includes information about the two modulations applied by modulators M1 and M2. The other pulses enter fiber section F3 separated from one another because they follow optical paths of different lengths.

The (encoded) quantum signal SQ on fiber section F3 then passes to one of optical fiber sections F4 and F4′, depending on the overall selective random modulation (e.g., phase or polarization) imparted to the quantum signal by (phase or polarization) modulators M1 and M2. Quantum signal SQ then passes through one of optical gates 28 and 28′, which are activated (e.g., switched to the open state) by respective timed electronic gating signals S28 and S28′ from controller 40. Quantum signal SQ is then detected by the corresponding one of SPDs 30 and 30′, which are electronically gated by timed gating signals S30 and S30′ from controller 40.

The process is repeated for a large number of quantum signals, which are processed according to known QKD techniques to establish a secret key between QKD stations QA and QB.

### Dual Gating of the SPDs

A key aspect of the present invention involves dual gating of the SPDs by both electrical and optical means to reduce detection noise. In the present invention, controller 40 is adapted to control the operation of optical gates 28 and 28′ via electronic gating signals S28 and S28′, and SPDs 30 and 30′ via electronic SPD gating signals S30 and S30′.

FIG. 4 is a timing diagram illustrating the timing of the electronic gating of optical gates 28 and 28′ and the electronic gating of corresponding SPDs 30 and 30′. Optical gates 28 and 28′ each have an associated window WOG. Window WOG has a width TOG defined by gating signals S28 and S28′. Also, quantum signal SQ has a width TSQ.

Likewise, SPDs 30 and 30′ each have an associated window WSPD having a width TSPD defined by SPD gating signals S30 and S30′. In the present invention, TSPD>TOG. Also, in practice, the width TSPD of window WSPD is the same for each SPD, and the width TOG of window WOG is the same for each optical gate. This type of gating is assumed in the discussion below, though strictly speaking this need not be the case.

In an example embodiment, quantum signal SQ has a width of about 20 ps, which is significantly narrower than the ˜50 ps widths of typical quantum signals used in QKD. Further in an example embodiment, the SPD window width TSPD is about 1 nanosecond (ns), and the optical gate window width TOG is about 50 ps. Use of a high-speed optical switch such as a lithium niobate modulator ensures a sharp (i.e., high extinction ratio) optical gate window WOG.

Windows WSPD and WOG are timed to be centered about quantum signal SQ, as shown in FIG. 4. While the precise width TSPD of the SPD window WSPD varies by as much as 500 ps due to jitter, the width TOG of the optical gate window WOG has no significant jitter. Accordingly, optical gate window with TOG can be sized more closely to the quantum signal width TSQ.

The use of optical gating via optical gates 28 and 28′ (or a single optical gate 28) allows for the SPDs 30 and 30′ to be electronically gated in a manner that limits (e.g., minimizes or substantially reduces) the inherent electronic noise. This involves using a relatively wide SPD gating window WSPD as compared to the width of the quantum signal (e.g., TSPD ˜1 ns and TSQ ˜10 ps) without regard to the amount of scattered photons that might be detected. On the other hand, optical gates 28 and 28′ are provided with an optical gating window WOG relatively close in size to the width TSQ of the (encoded) quantum signal SQ being detected. In an example embodiment, the width TOG of optical gating window WOG is selected to limit (e.g., minimize or substantially reduce) the amount of scattered photons that would otherwise be detected by the SPDs.

Because the optical gate has insignificant jitter, the close optical gating of the quantum signal SQ drastically reduces the amount of optical noise in the SPDs from scattered photons. This allows for the quantum signals SQ to be discerned when the QKD stations of a QKD system are connected to a WDM network. Stated differently, the combination of electrical and optical gating of the SPDs allows for Fourier-transform-limited detection of the quantum signals, which in turn allows for detecting the relatively weak quantum signals in the presence of relatively strong photon-based noise in the WDM network.

The reduction in the amount of scattered light detected by the SPDs using the apparatus and methods of the present invention is approximated by the ratio of the widths of the optical and electronic gating windows. Thus, in the example described above, the reduction in scattered light is TOG/TSPD=20 ps/1 ns ˜17 dB. This level of noise reduction allows for the initial strength of the quantum signal in a two-way QKD system to be increased. Thus, for example, in a QKD system where only ˜1 GB/s was possible before, now ˜50 GB/s can be obtained.

In an example embodiment, a dispersion compensator DC is included in the optical path between QKD stations QA and QB (FIG. 2) to keep the width of the quantum signals sufficiently narrow.

In an example embodiment, QKD system Q includes a phase-lock-loop (PLL) technology in controllers 18 and 40, such as described in PCT Patent Application No. PCT/2004/003394, entitled “QKD systems with robust timing,” which patent application is incorporated by reference herein. Such timing technology allows for the coordinated the operation of the QKD system with negligible (e.g., ˜1 ps) timing jitter.

Also, in another example embodiment, the timed gating is accomplished using a single pulse. A single-pulse synchronization scheme uses one synchronization (“sync”) pulse for a corresponding one photon count or one time slot. This is opposite to a PLL design wherein both stations communicate with each other more frequently than the available time slots in the quantum channel.

### Two-Way QKD System Improvement

Also, the present invention improves the design and performance of the QKD system disclosed in the article “Automated ‘plug & play’ quantum key distribution,” by G. Ribordy, J.-D. Gautier, N. Gisin, O. Guinnard, H. Zbinden, Electronics Letters v. 34, n. 22, pp. 2116-2117, 1998 (hereinafter, “the Ribordy reference.”). The QKD system described therein utilizes one strong laser signal both for the quantum and the sync signals. However, to fight the Rayleigh scattering, a fiber spool is needed, with the length of this spool matching the length of the transmission line between Alice and Bob. This approach significantly reduces the actual key exchange rate. However, the use of optical and electronic gating of the SPDs according to the present invention allows for the elimination of the fiber spool because the gating methods and apparatus essentially eliminate the detection of Rayleigh-scattered photons.

### Security Improvements for Two-Way QKD System

The present invention provides additional security when applied to a two-way QKD system such as that disclosed in the Ribordy reference cited above. In a folded system, the present invention reduces Raleigh scattering by the aforementioned 17 dB. Therefore, the power in the outgoing pulses from Bob can be increased and higher attenuation used at Alice. This facilitates the use of a photodiode at Alice to detect an eavesdropper, since the eavesdropper would need to probe Alice with 17 dB more photons.

What is claimed is:

1. A method of reducing an amount of detected noise in a QKD system having one or more single-photon detectors (SPDs) adapted to detect a quantum signal having a quantum signal width, comprising:
electronically gating each SPD with a first gating signal that provides each SPD with a gating window having a first width centered on an expected arrival time of the quantum signal;
optically gating each SPD with an optical gate adapted to receive a second gating signal that provides the optical gate with a gating window having a second width centered on the expected arrival time of the quantum signal; and
wherein the first width is greater than the second width.

2. The method of claim 1, including selecting the first width to limit inherent electronic noise in the SPD.

3. The method of claim 2, including selecting the second width to limit an amount of scattered photons from being detected by each SPD while increasing the amount of quantum signals detected by each SPD.

4. The method of claim 1, wherein the second width is about the same as the quantum signal width.

5. The method of claim 1, including optically coupling each SPD to a separate optical gate.

6. A method of generating an encryption key, comprising:
generating and sending a plurality of quantum signals of a first wavelength between first and second QKD stations over a WDM network adapted to transmit multiple wavelengths including the first wavelength;
selectively randomly modulating each quantum signal at each QKD station; and
recording the respective modulations of said plurality of modulated quantum signals as a function of time using one or more single-photon detectors (SPDs), wherein said recording includes optically and electronically gating the one or more SPDs to limit an amount of scattered photons generated in the WDM network from being detected in the one or more SPDs as optical noise while limiting an amount of electronic noise in the one or more SPDs.

7. The method of claim 6, wherein said modulating includes phase modulating.

8. A method of detecting encoded quantum signals in a QKD system with one or more single-photon detectors (SPDs), comprising:
electronically gating each SPD with a first gating width; and
optical gating each SPD with a second gating width that is less than the first gating width.

9. A QKD system comprising:
a first QKD station adapted to generate a selectively randomly modulated quantum signal having a first wavelength and send it to a second QKD station over a WDM network adapted to transmit optical signals of different wavelengths including the first wavelength;
a second QKD station adapted to receive the modulated quantum signal and selectively randomly modulate the modulated quantum signal to form an encoded quantum signal;
one or more single-photon detectors (SPDs) in the second QKD station that are adapted to detect the encoded quantum signal and that are electronically gated with a first gating window to limit electronic noise when detecting the encoded quantum signal; and
one or more optical gates optically coupled to the one or more SPDs, wherein each optical gate is gated to correspond to an expected arrival time of the encoded quantum signal, and having a second gating window sized to limit an amount of scattered light from reaching the one or more SPDs.

10. The system of claim 9, wherein the second gating window associated with each optical gate is narrower than the first gating window associated with each SPD.

11. The system of claim 9, wherein the second gating window associated with each optical gate has a width substantially the same as a width of the encoded quantum signal.

12. The system of claim 9, including a single optical gate operably coupled to each of the one or more SPDs.

13. A QKD station adapted to detect an encoded quantum signal, comprising:
one or more single-photon detectors (SPDs);
one or more optical gates optically coupled to the one or more SPDs; and
a controller operably coupled to each SPD and each optical gate, the controller adapted to provide a first gating signal of a first width to each SPD and a second gating signal of a second width to each optical gate; and
wherein the second width is less than the first width.

14. The QKD station of claim 13, including a single optical gate Optically coupled to each of the one or more SPDs.
